(19) United States
(12) Patent Application Publication
(10) Pub. No.: US 2026/0238960 A1
(43) Pub. Date: Aug. 13, 2026

(54) INFORMATION PROCESSING APPARATUS, INFORMATION PROCESSING METHOD, AND PROGRAM

(71) Applicant: Sony Group Corporation, Tokyo (JP)

(72) Inventors: Yu SHIGETA, Tokyo (JP); Kazunobu SUMIYA, Kanagawa (JP); Yasuhiro ONOGI, Tokyo (JP)

(73) Assignee: Sony Group Corporation, Tokyo (JP)

(21) Appl. No.: 19/151,260

(22) PCT Filed: Jan. 23, 2024
(86) PCT No.: PCT/JP2024/001802

§ 371 Date: Jul. 25, 2025

(30) Foreign Application Priority Data
Feb. 21, 2023 (JP) 2023-024957

(51) Int. Cl. H04W 4/029; H04M 1/72427; H04M 1/72457; H04W 4/021

(52) U.S. Cl. CPC H04W 4/029; H04M 1/72427; H04M 1/72457; H04W 4/021; H04M 2201/42

(57) ABSTRACT

An information processing apparatus includes a display control unit that, in a case where a position on a map of a terminal apparatus staying in a designated region predetermined is corrected on the basis of position information acquired by the terminal apparatus, performs display indicating that the position on the map of the terminal apparatus has been corrected.

### TECHNICAL FIELD

The present technology relates to an information processing apparatus, an information processing method, and a program, and particularly relates to a technology for displaying a position of a mobile terminal on a display unit.

### BACKGROUND ART

Patent Document 1 discloses an information processing apparatus that, when it is detected that a user carrying a terminal apparatus that receives a GNSS signal has entered a geofence, displays a notification indicating that the user has entered the geofence on a display unit.

### CITATION LIST

### Patent Document

Patent Document 1: Japanese U.S. Pat. No. 7,103,337

### SUMMARY OF THE INVENTION

### Problems to be Solved by the Invention

By the way, for example, in a case where a user holding a terminal apparatus enters a building or the like, there is a case where the terminal apparatus cannot receive a GNSS signal, or even if the GNSS signal can be received, an error of position information can be large, and the position of the terminal apparatus may not be accurately measured.

In such a case, there is a problem that the information processing apparatus cannot accurately display the position of the terminal apparatus.

The present technology has been made in view of the above problems, and an object thereof is to display a position of a terminal apparatus in an easily understandable manner.

### Solutions to Problems

An information processing apparatus according to the present technology includes a display control unit that, in a case where a position on a map of a terminal apparatus staying in a predetermined designated region has been corrected on the basis of position information acquired by the terminal apparatus, performs display indicating that the position on the map of the terminal apparatus has been corrected.

As a result, in a case where the position of the terminal apparatus is corrected, the information processing apparatus can cause the user to grasp the correction.

### BRIEF DESCRIPTION OF DRAWINGS

FIG. 1 is a diagram illustrating a configuration of an information processing system as an embodiment according to the present technology.

FIG. 2 is a diagram illustrating a configuration of a mobile terminal.

FIG. 3 is a diagram illustrating a configuration of a server.

FIG. 4 is a diagram illustrating a configuration of a notification terminal.

FIG. 5 is a diagram illustrating a functional configuration of an information processing system.

FIG. 6 is a diagram for explaining a destination and a geofence.

FIG. 7 is a diagram for explaining entry and exit into and from a geofence.

FIG. 8 is a diagram for explaining in-out determination processing.

FIG. 9 is a diagram illustrating an example of an exit notification.

FIG. 10 is a diagram illustrating an example of a case where there is a problem in position information.

FIG. 11 is a diagram illustrating an example of correction display.

FIG. 12 is a diagram illustrating an example of correction display.

FIG. 13 is a diagram illustrating an example of correction display.

FIG. 14 is a diagram illustrating an example of correction display.

FIG. 15 is a diagram illustrating an example of correction display.
FIG. 16 is a diagram illustrating an example of correction display.
FIG. 17 is a diagram illustrating an example of correction display.
FIG. 18 is a diagram illustrating an example of correction display.
FIG. 19 is a diagram illustrating an example of correction display.
FIG. 20 is a diagram illustrating an example of correction display.
FIG. 21 is a diagram illustrating an example of correction display.
FIG. 22 is a diagram illustrating an example of correction display.
FIG. 23 is a diagram illustrating an example of correction display.
FIG. 24 is a sequence chart illustrating a flow of processing in the information processing system.
FIG. 25 is a flowchart illustrating a flow of stay determination processing.

### MODE FOR CARRYING OUT THE INVENTION

Hereinafter, embodiments according to the present technology will be described in the following order with reference to the accompanying drawings.
<1. Configuration of Information Processing System 1>
<2. Processing of Information Processing System 1>
<3. Modifications>
<4. Summary of Embodiments>
<5. Present Technology>

### 1. Configuration of Information Processing System 1

### 1-1. Overall Configuration of Information Processing System 1

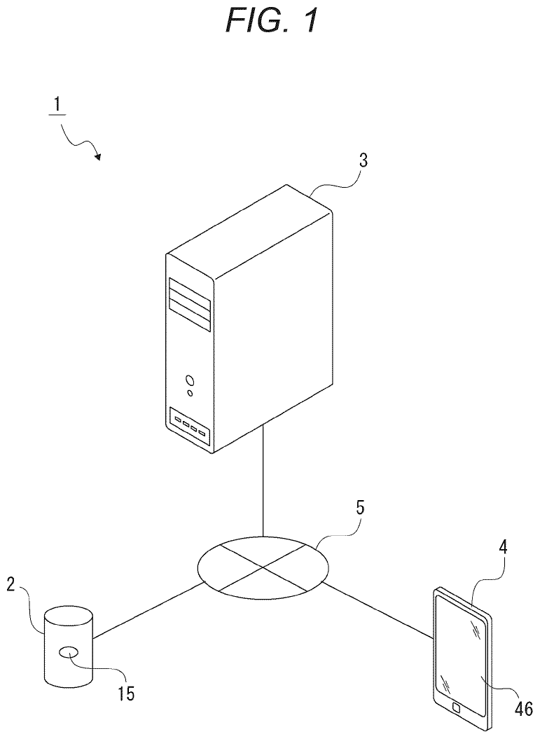

FIG. 1 is a diagram illustrating a configuration of an information processing system 1 as an embodiment according to the present technology. As illustrated in FIG. 1, the information processing system 1 includes a mobile terminal 2, a server 3, and a notification terminal 4. The mobile terminal 2, the server 3, and the notification terminal 4 are connected via a network 5 such as the Internet.

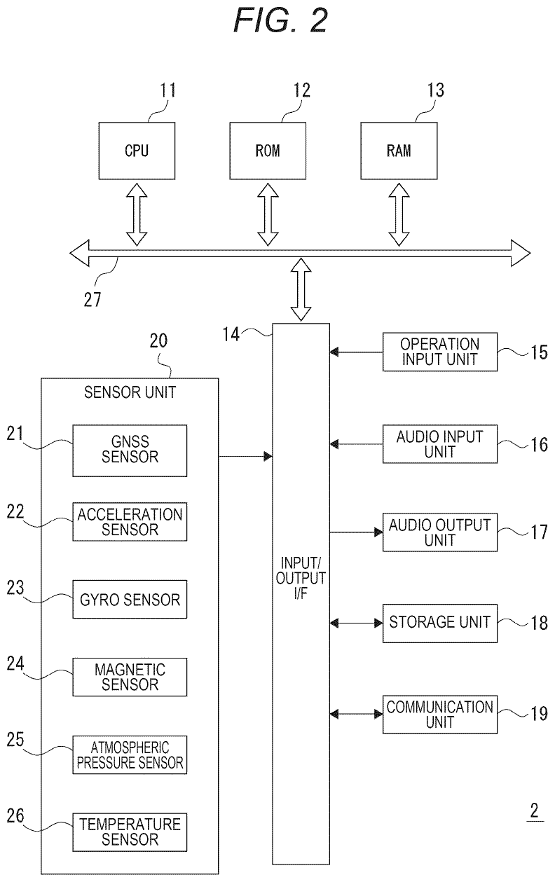

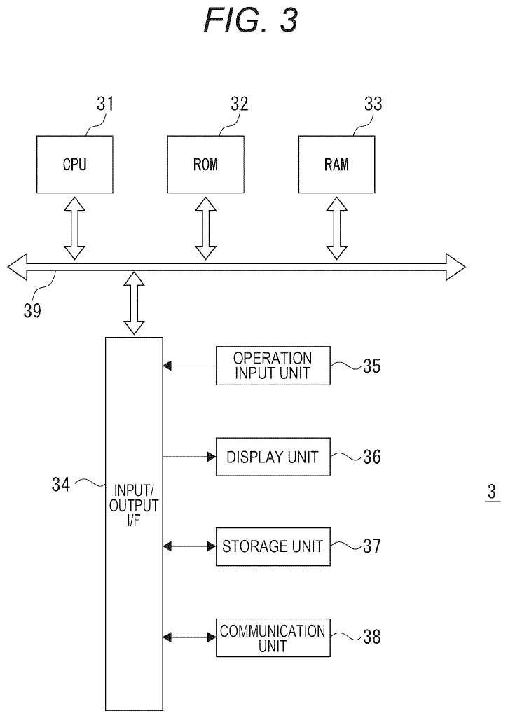

As will be described in detail later, the mobile terminal 2 is equipped with a global navigation satellite system (GNSS) sensor 21 (see FIG. 2), and can measure the position of the mobile terminal 2. In the information processing system 1, position information indicating the position of the mobile terminal 2 is transmitted to the server 3 at predetermined intervals.

In the server 3, an in-out determination to a geofence set around a predetermined destination is made on the basis of the position information transmitted from the mobile terminal 2. Then, in a case where it is determined that the mobile terminal 2 has entered or exited from the geofence, the server 3 notifies the notification terminal 4 that the mobile terminal 2 has entered or exited from the geofence. In addition, the server 3 can also notify the notification terminal 4 of the position and movement trajectory of the mobile terminal 2 in response to a request from the notification terminal 4.

As a use example of the information processing system 1, a child has the mobile terminal 2, and a parent of the child having the mobile terminal 2 owns the notification terminal 4. In this case, in the information processing system 1, by allowing the child to have the mobile terminal 2, it is possible to notify the parent's notification terminal 4 of the position of the child in real time, and to notify the parent's notification terminal 4 of the entry and exit of the child into and from the geofence in real time.

Note that the above-described use examples are merely examples, and other use methods may be used. For example, the mobile terminal 2 is not limited to being held by a child, and may be held by various persons such as an elderly person, or may be placed on a mobile body such as a vehicle.

Hereinafter, a person who holds the mobile terminal 2 will be described as a moving person, and a person who uses the notification terminal 4 will be described as a user.

### 1-2. Configuration of Mobile Terminal 2

FIG. 2 is a diagram illustrating a configuration of the mobile terminal 2. As illustrated in FIG. 2, the mobile terminal 2 includes a microcomputer including a central processing unit (CPU) 11, a read only memory (ROM) 12, and a random access memory (RAM) 13.

The CPU 11 executes various processes according to a program stored in the ROM 12 or a program loaded from the storage unit 18 into the RAM 13. In addition, the RAM 13 appropriately stores data and the like necessary for the CPU 11 to execute various processes.

The CPU 11, the ROM 12, and the RAM 13 are connected to one another via a bus 27. An input/output interface 14 is also connected to the bus 27.

An operation input unit 15, an audio input unit 16, an audio output unit 17, a storage unit 18, a communication unit 19, and a sensor unit 20 are connected to the input/output interface 14.

The operation input unit 15 includes an operator and an operation device, and is, for example, a button switch disposed substantially at the center of the mobile terminal 2 as illustrated in FIG. 1.

The audio input unit 16 is a microphone that inputs sound.

The audio output unit 17 is a speaker that outputs sound.

The storage unit 18 includes a hard disk, a solid-state memory, and the like, and can store various types of information.

The communication unit 19 communicates with the server 3 via the network 5.

The sensor unit 20 includes a plurality of sensors for acquiring various types of information. The sensor unit 20 includes, for example, a GNSS sensor 21, an acceleration sensor 22, a gyro sensor 23, a magnetic sensor 24, an atmospheric pressure sensor 25, and a temperature sensor 26.

The GNSS sensor 21 receives a global navigation satellite system (GNSS) signal from a GNSS satellite, and generates position information including the latitude and longitude of the mobile terminal 2 on the basis of the received GNSS signal. Note that the GNSS sensor 21 may receive the GNSS signal, and the CPU 11 may generate the position information on the basis of the GNSS signal.

The acceleration sensor 22 measures the acceleration of the mobile terminal 2.

The gyro sensor 23 measures the angular velocity of the mobile terminal 2.

The magnetic sensor 24 measures the magnitude and direction of magnetism (geomagnetism).

The atmospheric pressure sensor 25 measures atmospheric pressure.

The temperature sensor 26 measures temperature.

The GNSS sensor 21, the acceleration sensor 22, the gyro sensor 23, the magnetic sensor 24, the atmospheric pressure sensor 25, and the temperature sensor 26 output measurement results to the CPU 11.

Note that these sensors are examples, and the sensor unit 20 only needs to be able to measure at least the position of the mobile terminal 2, and may not include some of these sensors. Furthermore, the sensor unit 20 may include another sensor.

### 1-3. Configuration of Server 3

FIG. 3 is a diagram illustrating a configuration of the server 3. As illustrated in FIG. 3, the server 3 includes a microcomputer including a CPU 31, a ROM 32, and a RAM 33.

The CPU 31 executes various processes according to a program stored in the ROM 32 or a program loaded from the storage unit 37 into the RAM 33. In addition, the RAM 33 appropriately stores data and the like necessary for the CPU 31 to execute various processes.

The CPU 31, the ROM 32, and the RAM 33 are connected to one another via a bus 39. An input/output interface 34 is also connected to the bus 39.

An operation input unit 35, a display unit 36, a storage unit 37, and a communication unit 38 are connected to the input/output interface 34.

The operation input unit 35 includes an operator and an operation device, and is, for example, a keyboard, a mouse, a key, a dial, a touch panel, a touch pad, a remote controller, or the like.

The display unit 36 is a liquid crystal display (LCD), an organic EL panel, or the like, and displays various images (screens).

The storage unit 37 includes a hard disk, a solid-state memory, and the like, and can store various types of information.

The communication unit 38 communicates with the mobile terminal 2 and the notification terminal 4 via the network 5.

### 1-4. Configuration of Notification Terminal 4

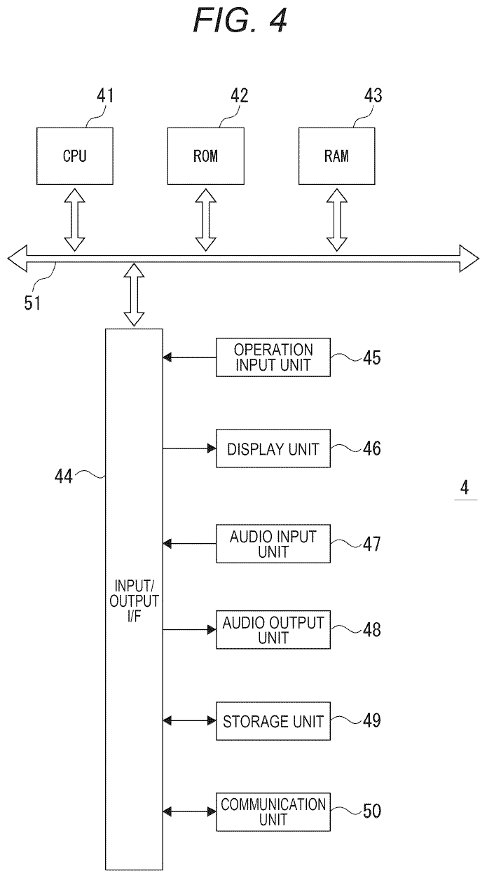

FIG. 4 is a diagram illustrating a configuration of the notification terminal 4. As illustrated in FIG. 4, the notification terminal 4 includes a microcomputer including a CPU 41, a ROM 42, and a RAM 43.

The CPU 41 executes various processes according to a program stored in the ROM 42 or a program loaded from the storage unit 49 into the RAM 43. In addition, the RAM 43 appropriately stores data and the like necessary for the CPU 41 to execute various processes.

The CPU 41, the ROM 42, and the RAM 43 are connected to one another via a bus 51. An input/output interface 44 is also connected to the bus 51.

An operation input unit 45, a display unit 46, an audio input unit 47, an audio output unit 48, a storage unit 49, and a communication unit 50 are connected to the input/output interface 44.

The operation input unit 45 includes an operator and an operation device, and is, for example, a button switch and a touch panel.

The display unit 46 is a liquid crystal display (LCD), an organic EL panel, or the like, and displays various images (screens).

The audio input unit 47 is a microphone that inputs sound.

The audio output unit 48 is a speaker that outputs sound.

The storage unit 49 includes a hard disk, a solid-state memory, and the like, and can store various types of information.

The communication unit 50 communicates with the server 3 via the network 5.

### 1-5. Functional Configuration of Information Processing System 1

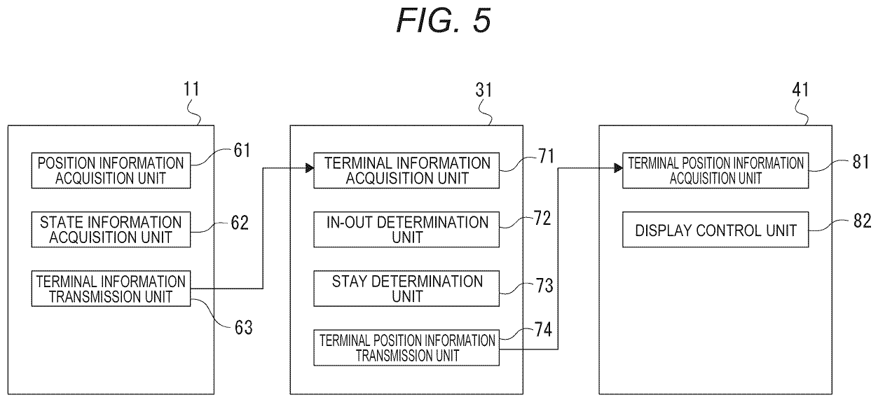

FIG. 5 is a diagram illustrating a functional configuration of the information processing system 1. As illustrated in FIG. 5, the CPU 11 of the mobile terminal 2 functions as a position information acquisition unit 61, a state information acquisition unit 62, and a terminal information transmission unit 63.

The position information acquisition unit 61 acquires position information indicating the position of the mobile terminal 2 measured by the GNSS sensor 21.

The state information acquisition unit 62 acquires state information including the acceleration measured by the acceleration sensor 22, the angular velocity measured by the gyro sensor 23, the magnetism measured by the magnetic sensor 24, the atmospheric pressure measured by the atmospheric pressure sensor 25, and the temperature measured by the temperature sensor 26.

The terminal information transmission unit 63 stores the position information acquired by the position information acquisition unit 61 and the state information acquired by the state information acquisition unit 62 in the storage unit 18 as terminal information, and transmits the terminal information to the server 3. Note that the terminal information transmission unit 63 may transmit only a part of the state information acquired by the state information acquisition unit 62 or may not transmit the state information.

The CPU 31 of the server 3 functions as a terminal information acquisition unit 71, an in-out determination unit 72, a stay determination unit 73, and a terminal position information transmission unit 74.

The terminal information acquisition unit 71 acquires terminal information (position information or state information) transmitted from the mobile terminal 2.

The in-out determination unit 72 performs in-out determination processing of determining whether the mobile terminal 2 has entered or exited from the geofence on the basis of the terminal information acquired by the terminal information acquisition unit 71.

In a case where the in-out determination unit 72 determines that the mobile terminal 2 has entered the geofence, the stay determination unit 73 performs stay determination processing of determining whether the mobile terminal 2 stays in the geofence, more specifically, at the destination.

The terminal position information transmission unit 74 transmits the terminal information transmitted from the mobile terminal 2 and the terminal position information related to the position of the mobile terminal 2 including the determination results of the in-out determination unit 72 and the stay determination unit 73 to the notification terminal 4.

The CPU 41 of the notification terminal 4 functions as a terminal position information acquisition unit 81 and a display control unit 82.

The terminal position information acquisition unit 81 acquires terminal position information transmitted from the server 3.

The display control unit 82 controls image display on the display unit 46 on the basis of the terminal position information acquired by the terminal position information acquisition unit 81.

Hereinafter, processing performed by each functional unit of the mobile terminal 2, the server 3, and the notification terminal 4 will be described.

### 2. Processing of Information Processing System 1

### 2-1. Description of Destination and Geofence

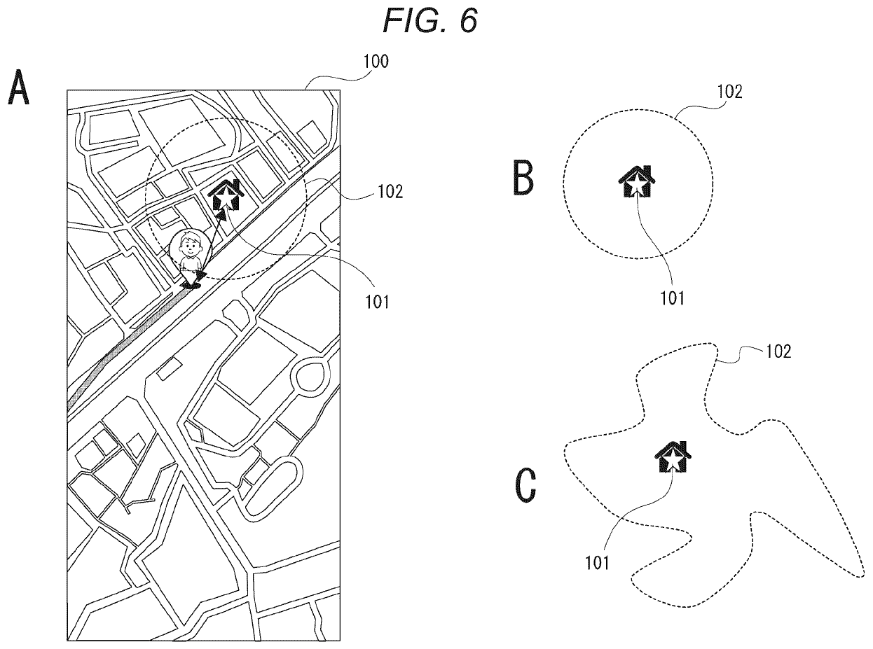

FIG. 6 is a diagram for explaining a destination and a geofence. FIG. 6A is a diagram illustrating a map 100 displayed on the display unit 46. FIG. 6B is a diagram illustrating a circular geofence 102. FIG. 6C is a diagram illustrating the geofence 102 having an arbitrary shape.

In the server 3, the geofence 102 is set in advance. Here, the geofence 102 is a region surrounded by a virtual boundary on geographic coordinates.

Specifically, as illustrated in FIG. 6A, in the notification terminal 4, when a specific position on the map 100 displayed on the display unit 46 is operated via the operation input unit 45, the position can be set as the destination 101. Note that the destination 101 is actually a coordinate point indicated by latitude and longitude, and is indicated by, for example, a star-shaped icon on the map 100.

Furthermore, the notification terminal 4 can set a predetermined region including the destination 101 as the geofence 102.

The geofence 102 may be set in a circular shape having a predetermined radius centered on the destination 101 as illustrated in FIG. 6B, or may be set in an arbitrary shape to include the destination 101 as illustrated in FIG. 6C. However, in the following description, a case where the geofence 102 is set to a circular shape will be described as an example.

The geofence 102 is actually a region indicated by, for example, a radius from the destination 101 or the latitude and longitude of the boundary of the geofence 102, and is indicated by, for example, a broken line on the map 100.

In the notification terminal 4, when the destination 101 and the geofence 102 are set, information indicating the destination 101 and the geofence 102 is transmitted to the server 3. In the server 3, information indicating the destination 101 and the geofence 102 transmitted from the notification terminal 4 is stored in the storage unit 37.

Note that, in the present embodiment, a case where the geofence 102 is set with respect to the destination 101 will be described, but the destination 101 does not need to be set when the geofence 102 is set. That is, the geofence 102 can be independently set to the destination 101.

### 2-2. In-Out Determination Processing and Notification of Entry or Exit

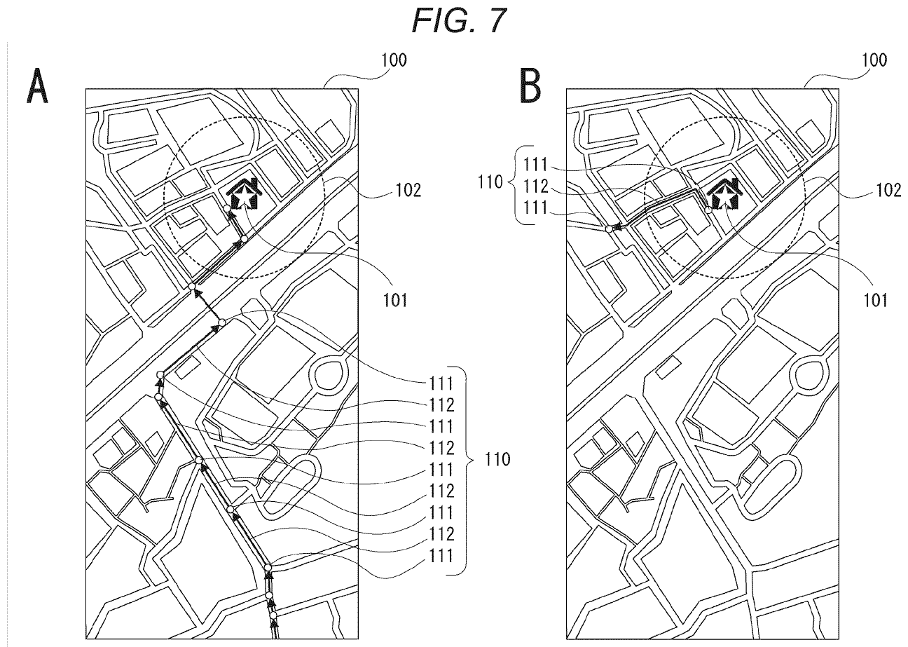

FIG. 7 is a diagram for explaining entry and exit into and from the geofence 102. Fig. ZA is a diagram illustrating a map 100 in a case where the mobile terminal 2 enters the geofence 102. FIG. 7B is a diagram illustrating a map 100 in a case where the mobile terminal 2 has exited from inside the geofence 102.

As illustrated in FIGS. 7A and 7B, in the notification terminal 4, a movement trajectory 110 of the mobile terminal 2 can be superimposed on the map 100 and displayed on the display unit 46.

The terminal information acquisition unit 71 of the server 3 acquires the position information from the mobile terminal 2 at predetermined intervals (for example, every one minute or every two minutes). When acquiring the position information, the terminal information acquisition unit 71 stores the acquired position information in the storage unit 37 in association with the time of acquisition.

Then, when receiving a request to display the movement trajectory 110 from the notification terminal 4, the terminal position information transmission unit 74 transmits the position information stored in the storage unit 37 to the notification terminal 4. In the notification terminal 4, when the terminal position information acquisition unit 81 acquires the position information, the display control unit 82 displays the map 100 as illustrated in FIGS. 7A and 7B on the display unit 46 on the basis of the acquired position information.

The display control unit 82 acquires surrounding map data including the latitude and longitude indicated by the position information from the server 3 or another apparatus, and superimposes and displays the movement trajectory 110 on the map 100 based on the acquired map data. The movement trajectory 110 includes a position icon 111 arranged at a position indicated by the position information and a movement route 112 connecting positions based on the position information adjacent in time series.

As a result, the notification terminal 4 can confirm the movement trajectory 110 of the mobile terminal 2, that is, the movement of the moving person holding the mobile terminal 2 on the map 100.

In addition, the in-out determination unit 72 performs in-out determination processing of determining whether the mobile terminal 2 has entered or exited from the geofence 102 on the basis of the position information acquired from the mobile terminal 2 at predetermined intervals.

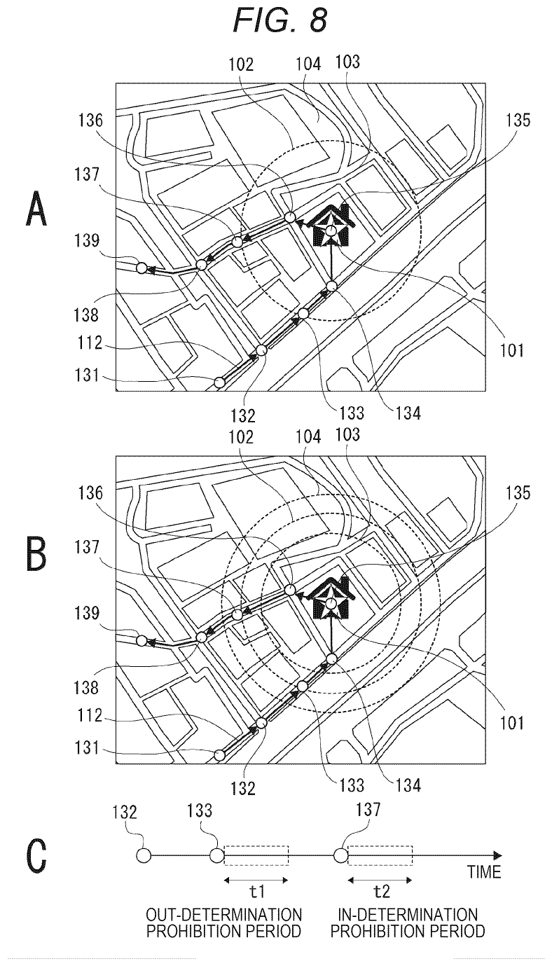

FIG. 8 is a diagram for explaining in-out determination processing. FIG. 8A is a diagram for explaining in-out determination processing using the geofence 102. FIG. 8B is a diagram for explaining in-out determination processing in which the geofence 102 has spatial hysteresis. FIG. 8C is a diagram for explaining in-out determination processing in which the geofence 102 has temporal hysteresis.

As illustrated in FIG. 8A, it is assumed that the mobile terminal 2 sequentially moves the position indicated by the position icon 131 to 139. In this case, the in-out determination unit 72 determines that the mobile terminal 2 has entered the geofence 102 when the mobile terminal 2 has moved from the position corresponding to the position icon 132 outside the geofence 102 to the position corresponding to the position icon 133 inside the geofence 102. That is, the in-out determination unit 72 determines that the mobile terminal 2 has entered the geofence 102 at the time when the position information of the position corresponding to the position icon 133 has been acquired.

In addition, when the position of the mobile terminal 2 moves from the position corresponding to the position icon 136 inside the geofence 102 to the position corresponding to the position icon 137 outside the geofence 102, the in-out determination unit 72 determines that the mobile terminal 2 has exited from the geofence 102. That is, the in-out determination unit 72 determines that the mobile terminal 2 has exited to the outside of the geofence 102 at the time when the position information of the position corresponding to the position icon 137 has been acquired.

In this manner, the in-out determination unit 72 determines that the mobile terminal 2 has entered or exited the geofence 102 when the mobile terminal 2 moves across the geofence 102 on the basis of the position information. However, the in-out determination unit 72 may determine entry and exit by providing spatial or temporal hysteresis to the geofence 102.

For example, in a case of providing spatial hysteresis, as illustrated in FIG. 8B, the in-out determination unit 72 sets a circular in-determination geofence 103 having a diameter smaller than that of the geofence 102, and sets a circular out-determination geofence 104 having a diameter larger than that of the geofence 102.

Then, the in-out determination unit 72 determines that the mobile terminal 2 has entered the geofence 102 when the mobile terminal 2 has moved from the position corresponding to the position icon 133 outside the in-determination geofence 103 to the position corresponding to the position icon 134 inside the in-determination geofence 103. That is, the in-out determination unit 72 determines that the mobile terminal 2 has entered the geofence 102 at the time when the position information of the position corresponding to the position icon 134 has been acquired.

Furthermore, when the position of the mobile terminal 2 has moved from the position corresponding to the position icon 137 inside the out-determination geofence 104 to the position corresponding to the position icon 138 outside the out-determination geofence 104, the in-out determination unit 72 determines that the mobile terminal 2 has exited the geofence 102. That is, the in-out determination unit 72 determines that the mobile terminal 2 has exited to the outside of the geofence 102 at the time when the position information of the position corresponding to the position icon 138 has been acquired.

In the case of providing the temporal hysteresis, as illustrated in FIG. 8C, when determining that the mobile terminal 2 has entered the geofence 102 at the time when the position information of the position corresponding to the position icon 133 has been acquired similarly to FIG. 8A, the in-out determination unit 72 sets the out-determination prohibition period t1 from the time. The out-determination prohibition period t1 is a period in which it is not determined whether or not the mobile terminal 2 exits the geofence 102.

Then, the in-out determination unit 72 determines whether or not the mobile terminal 2 has exited the geofence 102 after the out-determination prohibition period t1 has elapsed. Then, when the in-out determination unit 72 determines that the mobile terminal 2 has exited to the outside of the geofence 102 at the time when the position information of the position corresponding to the position icon 137 has been acquired, similarly to FIG. 8A, the in-out determination unit 72 sets an in-determination prohibition period t2 from the time. The in-determination prohibition period t2 is a period in which determination as to whether or not the mobile terminal 2 enters the geofence 102 is not performed.

As described above, the in-out determination unit 72 performs the in-out determination processing with spatial or temporal hysteresis provided to the geofence 102, so that the in-out determination processing can be accurately performed even in a case where an error is included in the position information of the mobile terminal 2.

Note that the in-out determination unit 72 may perform the in-out determination processing having both the spatial hysteresis illustrated in FIG. 8B and the temporal hysteresis illustrated in FIG. 8C.

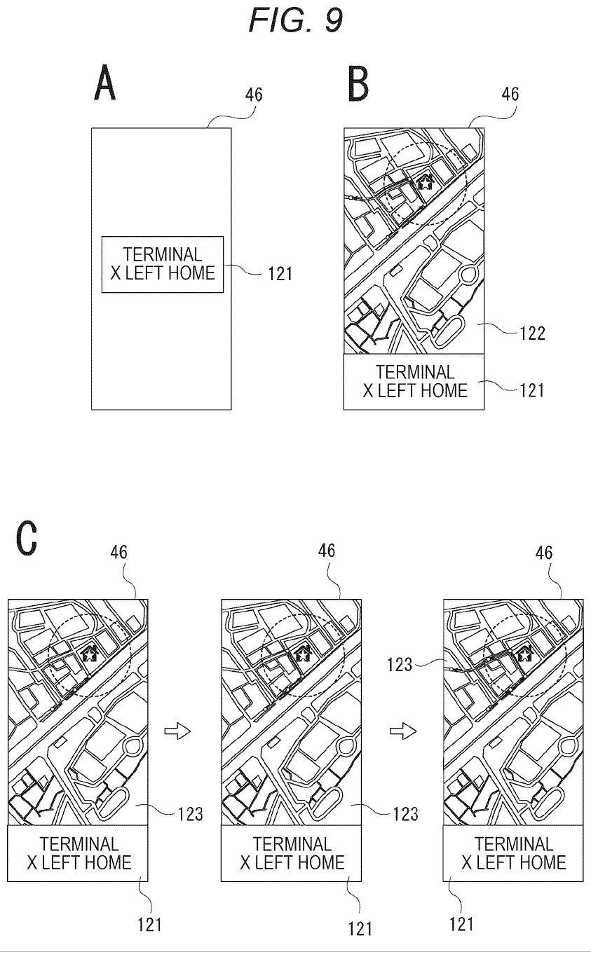

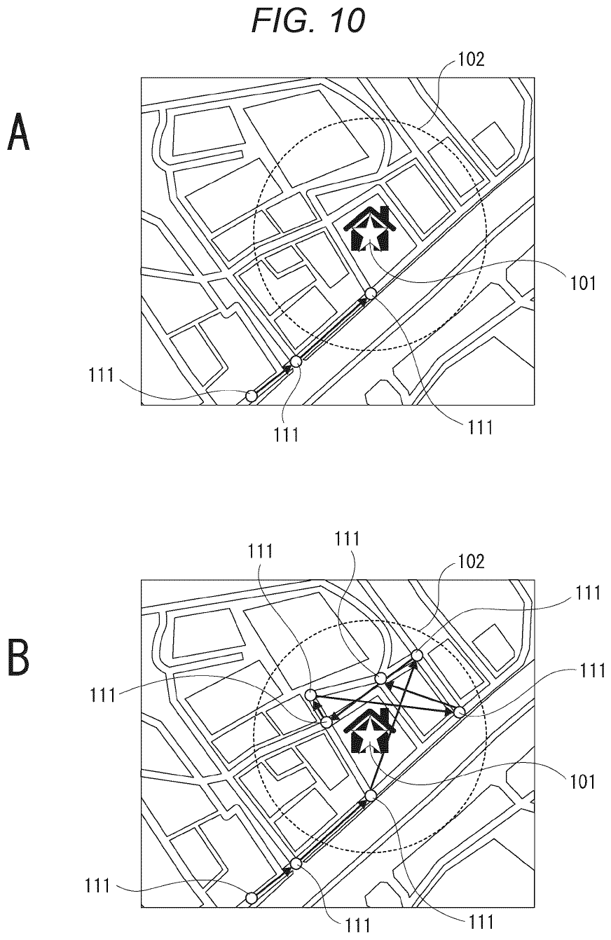

FIGS. 9A to 9C are diagrams illustrating an example of the exit notification.

In a case where the in-out determination unit 72 determines that the mobile terminal 2 has entered the geofence 102, the terminal position information transmission unit 74 transmits entry information indicating that the mobile terminal 2 has entered the geofence 102 to the notification terminal 4.

In addition, in a case where the in-out determination unit 72 determines that the mobile terminal 2 has exited from the geofence 102, the terminal position information transmission unit 74 transmits exit information indicating that the mobile terminal 2 has exited from the geofence 102 to the notification terminal 4.

The entry information and the exit information may be associated with position information when the mobile terminal 2 enters or exits the geofence 102.

When the notification terminal 4 receives the entry information or the exit information, the display control unit 82 notifies the entry or the exit via the display unit 46 on the basis of the received entry information or exit information.

For example, when the exit information is received, as illustrated in FIG. 9A, the display control unit 82 causes the display unit 46 to display a notification bar 121 for notifying that the mobile terminal 2 has exited from the geofence 102. In the notification bar 121, for example, characters such as “Terminal X left home” are written.

Furthermore, as illustrated in FIG. 9B, the display control unit 82 may display the map image 122 based on the position information on the display unit 46 together with the notification bar 121. On the map image 122, the movement trajectory 110 of the mobile terminal 2 based on the position information is displayed on the map 100.

Furthermore, as illustrated in FIG. 9C, the display control unit 82 may display the map image 123 based on the position information on the display unit 46 together with the notification bar 121. On the map image 123, the movement trajectory 110 of the mobile terminal 2 based on the position information is displayed in animation in chronological order on the map 100.

In this manner, the display control unit 82 displays the notification bar 121 and the map images 122 and 123 on the display unit 46 on the basis of the exit information, thereby notifying that the mobile terminal 2 has left the geofence 102, that is, that the moving person holding the mobile terminal 2 has left the geofence 102.

Note that, even when the entry information is received, the display control unit 82 displays the notification bar 121 and the map images 122 and 123 on the display unit 46 in a manner similar to when the exit information is received, thereby notifying that the moving person holding the mobile terminal 2 has entered the geofence 102.

### 2-3. Stay Determination Processing

FIG. 10 is a diagram illustrating an example of a case where there is a problem in the position information. FIG. 10A is a diagram illustrating an example of a case where the position information cannot be received. FIG. 10B is a diagram illustrating an example of a case where the error of the position information is large.

The destination 101 described above may be set at a position where a structure such as a building or a house stands. In such a case, when a moving person holding the mobile terminal 2 approaches the destination 101 or enters a building set at the destination 101, the mobile terminal 2 is blocked by the building and cannot receive the GNSS signal, receives the GNSS signal reflected by the building, or weakens the GNSS signal. In such a case, the GNSS sensor 21 cannot generate (measure) the position information, or an error of the position information increases.

For example, it is assumed that a moving person holding the mobile terminal 2 enters a building set as the destination 101, so that the GNSS sensor 21 cannot receive the GNSS signal and cannot generate the position information.

In this case, as illustrated in FIG. 10A, after the position icon 111 is displayed around the destination 101, the position icon 111 is not displayed during a period in which the position information cannot be generated. Then, the user who has confirmed the position of the mobile terminal 2 with the notification terminal 4 may misunderstand that the moving person holding the mobile terminal 2 has not arrived at the destination 101.

In addition, in a case where the error of the position information generated by the GNSS sensor 21 is large when the moving person holding the mobile terminal 2 enters the building set as the destination 101, as illustrated in FIG. 10B, the position icon 111 displayed on the basis of the position information frequently moves around the destination 101 and is displayed. Then, the user who has confirmed the position of the mobile terminal 2 with the notification terminal 4 may misunderstand that the moving person holding the mobile terminal 2 is moving around the destination 101 or has not reached the destination 101.

Therefore, the stay determination unit 73 determines whether the mobile terminal 2 stays in the geofence 102, more specifically, in the destination 101. Then, in a case where the stay determination unit 73 determines that the mobile terminal 2 stays at the destination 101, the notification terminal 4 corrects and displays the position icon 111 on the map 100 so that the mobile terminal 2 stays at the destination 101 (in the geofence 102).

Specifically, the stay determination unit 73 performs the stay determination processing during an in-determination period in which it is determined in the in-out determination processing that the mobile terminal 2 has entered the geofence 102 and it is not determined that the mobile terminal 2 has exited the geofence 102.

The stay determination unit 73 determines that the mobile terminal 2 stays at the destination 101 in a case where the stay condition is satisfied during the in-determination period.

The stay condition is a condition for determining that the mobile terminal 2 stays at the destination 101 and does not move. The stay condition is roughly divided into a condition based on acceleration, a condition based on position information, a condition using a vital sensor, and a condition based on an application by a moving person.

Hereinafter, a condition based on acceleration, a condition based on position information, a condition using a vital sensor, and a condition based on an application by a moving person will be described with examples. Note that the stay determination unit 73 may perform the stay determination using one of the conditions described below, or may perform the stay determination using a plurality of conditions.

In a case where the mobile terminal 2 stays at the destination 101, the mobile terminal 2 hardly moves, so that the acceleration of the mobile terminal 2 has a low value.

Therefore, as an example of the condition based on the acceleration, it is set that the acceleration of the mobile terminal 2 becomes equal to or less than a predetermined threshold value over a certain period. Note that the certain period and the predetermined threshold value may be fixed, or may be dynamically determined by the value of the acceleration.

The stay determination unit 73 determines whether the acceleration of the mobile terminal 2 has become equal to or less than a predetermined threshold value over a certain period on the basis of the acceleration (acceleration measured by the acceleration sensor 22) included in the terminal information transmitted from the mobile terminal 2. Then, the stay determination unit 73 determines that the mobile terminal 2 stays at the destination 101 in a case where the acceleration of the mobile terminal 2 is equal to or less than a predetermined threshold value over a certain period.

Note that the CPU 11 of the mobile terminal 2 may determine whether the acceleration of the mobile terminal 2 has become equal to or less than a predetermined threshold value over a certain period, and in a case where the acceleration of the mobile terminal 2 has become equal to or less than the predetermined threshold value over the certain period, the stay determination unit 73 may determine that the mobile terminal 2 stays at the destination 101 by transmitting information indicating the fact to the server 3.

In addition, as another example of the condition based on the acceleration, it is set that the differential value of the acceleration becomes equal to or less than a predetermined threshold value over a certain period. Note that the certain period and the predetermined threshold value may be fixed, or may be dynamically determined by the value of the acceleration.

The stay determination unit 73 calculates a differential value of the acceleration on the basis of the acceleration (the acceleration measured by the acceleration sensor 22) included in the terminal information transmitted from the mobile terminal 2, and determines whether the differential value of the calculated acceleration has become equal to or less than a predetermined threshold value over a certain period. Then, the stay determination unit 73 determines that the mobile terminal 2 stays at the destination 101 in a case where the differential value of the acceleration becomes equal to or less than a predetermined threshold value over a certain period.

Note that the CPU 11 of the mobile terminal 2 may determine whether the differential value of the acceleration of the mobile terminal 2 has become equal to or less than a predetermined threshold value over a certain period, and in a case where the differential value of the acceleration of the mobile terminal 2 has become equal to or less than the predetermined threshold value over the certain period, the stay determination unit 73 may determine that the mobile terminal 2 stays at the destination 101 by transmitting information indicating that the differential value has become equal to or less than the predetermined threshold value to the server 3.

Furthermore, as another example of the condition based on the acceleration, a condition using machine learning for the acceleration transmitted from the mobile terminal 2 during the in-determination period is set. In this case, the stay determination unit 73 performs machine learning in advance on the acceleration when the mobile terminal 2 stays at the destination 101, and substitutes the acceleration included in the terminal information transmitted from the mobile terminal 2 into the model subjected to the machine learning, thereby determining whether or not the mobile terminal 2 stays at the destination 101.

Next, the condition based on the position information will be described. In a case where the destination 101 is a building, the mobile terminal 2 may not be able to receive the GNSS signal, or the accuracy of the GNSS signal received by the mobile terminal 2 may be low.

Therefore, as an example of the condition based on the position information, it is set that the position information is not acquired over a certain period of time. Note that the certain period may be fixed, or may be dynamically determined.

The stay determination unit 73 determines whether the position information transmitted from the mobile terminal 2 has not been acquired over a certain period of time. Then, in a case where the position information has not been acquired for a certain period of time, the stay determination unit 73 determines that the mobile terminal 2 stays at the destination 101.

In addition, in a case where the mobile terminal 2 stays at the destination 101, the mobile terminal 2 hardly moves. Therefore, as another example of the condition based on the position information, it is set that the speed calculated on the basis of the position information is equal to or less than a predetermined threshold value over a certain period. Note that the certain period and the predetermined threshold value may be fixed or may be dynamically determined.

The stay determination unit 73 calculates the speed on the basis of the position information transmitted from the mobile terminal 2, and determines whether the calculated speed is equal to or less than a predetermined threshold value over a certain period. Then, the stay determination unit 73 determines that the mobile terminal 2 stays at the destination 101 in a case where the speed is equal to or less than a predetermined threshold value for a certain period of time.

Note that one or both of the calculation of the speed and the determination as to whether the speed is equal to or less than a predetermined threshold value over a certain period may be performed by the CPU 11 of the mobile terminal 2.

In addition, in a case where the destination 101 is a building, there is a possibility that the positional accuracy deteriorates even if the mobile terminal 2 has been able to generate the positional information. Therefore, as another example of the condition based on the position information, it is set that the positional accuracy is equal to or less than a predetermined threshold value over a certain period.

Here, the positional accuracy is calculated by comprehensively determining the number of GNSS satellites capable of receiving the GNSS signal, and the degree of variation in calculated latitude and longitude. Note that the certain period and the predetermined threshold value may be fixed, or may be dynamically determined by a value of positional accuracy.

The stay determination unit 73 calculates the positional accuracy on the basis of the positional information transmitted from the mobile terminal 2, and determines whether the calculated positional accuracy is equal to or less than a predetermined threshold value over a certain period of time. Then, the stay determination unit 73 determines that the mobile terminal 2 stays at the destination 101 in a case where the positional accuracy is equal to or less than a predetermined threshold value for a certain period of time.

Note that the positional accuracy may be calculated by the CPU 11 or the GNSS sensor 21 of the mobile terminal 2.

In addition, in a case where the mobile terminal 2 stays at the destination 101, that is, in a case where the moving person stays at the destination 101, since the movement of the moving person is small, for example, the heart rate is difficult to increase. Therefore, as an example of the condition using the vital sensor, for example, it is set that the heart rate is equal to or less than a predetermined threshold value.

In a case where a moving person holding the mobile terminal 2 holds a vital sensor capable of measuring biological information (for example, a heart rate) and the mobile terminal 2 can acquire a pulse rate as biological information from the vital sensor, the server 3 acquires the pulse rate from the mobile terminal 2. Then, the stay determination unit 73 determines whether the heart rate is equal to or less than a predetermined threshold value. Then, in a case where the heart rate is equal to or less than the predetermined threshold value, the stay determination unit 73 determines that the mobile terminal 2 stays at the destination 101.

Note that the CPU 11 of the mobile terminal 2 may determine whether the heart rate is equal to or less than a predetermined threshold value.

In addition, as an example of the condition based on the application by the moving person, it is set that the moving person has applied for staying at the destination 101 via the operation input unit 15 of the mobile terminal 2. In a case where the mobile terminal 2 applies that the moving person stays at the destination 101 via the operation input unit 15 of the mobile terminal 2, the mobile terminal 2 transmits information indicating the application to the server 3. In a case of receiving the information indicating that the application has been made, the stay determination unit 73 determines that the mobile terminal 2 stays at the destination 101.

The stay determination unit 73 may perform the stay determination by adding an additional condition described below in addition to the above-described condition.

For example, in a case where the position information cannot be acquired from the mobile terminal 2, the stay determination unit 73 calculates the moving speed of the mobile terminal 2 on the basis of the position information immediately before and one ahead of the time when the position information cannot be acquired. Then, the stay determination unit 73 determines whether the mobile terminal 2 reaches at the destination 101 in a case where the mobile terminal 2 moves at a speed calculated from the position based on the position information immediately before the acquisition is disabled. Then, in a case of determining that the mobile terminal 2 can reach the destination 101, the stay determination unit 73 determines that the mobile terminal 2 stays at the destination 101.

In addition, in a case where the position information cannot be acquired from the mobile terminal 2, the stay determination unit 73 calculates the movement vector of the mobile terminal 2 on the basis of the position information immediately before and one ahead of the time when the position information cannot be acquired. Then, the stay determination unit 73 determines whether the mobile terminal 2 reaches at the destination 101 in a case where the mobile terminal 2 moves with a movement vector calculated from a position based on the position information immediately before the acquisition is disabled. Then, in a case of determining that the mobile terminal 2 can reach the destination 101, the stay determination unit 73 determines that the mobile terminal 2 stays at the destination 101.

In addition, the stay determination unit 73 determines action identification of the mobile terminal 2 on the basis of the terminal information received from the mobile terminal 2. The action identification indicates how the mobile terminal 2 is moving (moving means), and the stay determination unit 73 determines, for example, whether the mobile terminal 2 is moving by automobile, bicycle, or walk. Note that the action identification can be detected on the basis of various types of information measured by the sensor unit 20, and the detection of the action identification may be performed by the mobile terminal 2.

The stay determination unit 73 determines whether or not the mobile terminal 2 can reach the destination 101 when the mobile terminal 2 moves with the determined action identification from the position based on the position information immediately before the acquisition is disabled. Then, in a case of determining that the mobile terminal 2 can reach the destination 101, the stay determination unit 73 determines that the mobile terminal 2 stays at the destination 101.

Furthermore, in a case where the position information is received from the mobile terminal 2, the stay determination unit 73 may change the threshold values of the various conditions described above on the basis of the positional accuracy. For example, in a case where it is determined that the positional accuracy is poor, the threshold value is increased to make it easier to determine that the mobile terminal 2 stays at the destination 101. In addition, for example, in a case where it is determined that the accuracy of the positional accuracy is high, the threshold value is reduced, and it is difficult to determine that the mobile terminal 2 stays at the destination 101.

In a case of determining that the mobile terminal 2 stays at the destination 101 as a result of the stay determination, the stay determination unit 73 corrects the position of the mobile terminal 2 to the position of the destination 101. The terminal position information transmission unit 74 transmits position information indicating the corrected position to the notification terminal 4 together with correction information indicating that the position information has been corrected.

Upon receiving the correction information, the notification terminal 4 displays, on the display unit 46, the fact that the position of the mobile terminal 2 has been corrected and notifies the user of the fact.

### 2-4. Correction Display

FIGS. 11 to 23 are diagrams illustrating examples of correction display. In a case where the notification terminal 4 performs display indicating that the position of the mobile terminal 2 on the map 100 has been corrected to the position of the destination 101, the display control unit 82 performs display in a display pattern as in the example illustrated in FIGS. 11 to 23.

Note that the notification terminal 4 only needs to be able to execute at least one of the display patterns illustrated in FIGS. 11 to 23, and may be able to execute a plurality of display patterns or may be able to execute a display pattern obtained by combining the display patterns. Furthermore, the display patterns illustrated in FIGS. 11 to 23 are examples, and the color, shape, and the like are not limited thereto.

In the examples illustrated in FIGS. 11 to 23, when systematically classified, the patterns can be classified into a pattern in which the color of the position icon of the corrected position is changed and displayed, a pattern in which the shape of the position icon of the corrected position is changed and displayed, a pattern in which supplementary information is displayed around the position icon of the corrected position, a pattern in which animation is displayed around the position icon of the corrected position, and a combination of these patterns.

In the pattern in which the color of the position icon is changed and displayed, as illustrated in FIG. 11, the display control unit 82 displays the position icon 111 corresponding to the position that has not been corrected in a white circle. In addition, the display control unit 82 displays the position icon 201 corresponding to the corrected position in a black circle having a color different from that of the position icon 111.

As a result, since the color of the position icon 201 is different from the color of the normal position icon 111 that has not been corrected, the user can easily grasp that the position has been corrected.

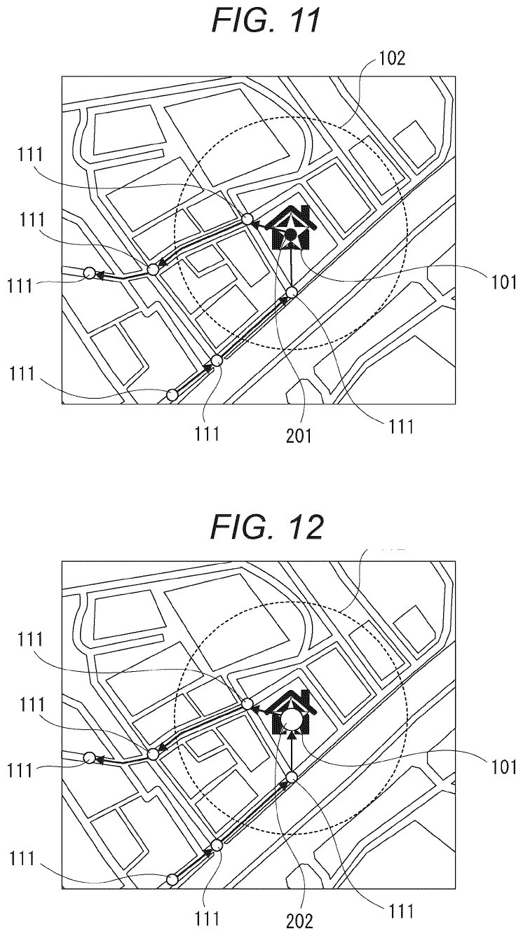

In the pattern in which the shape of the position icon is changed and displayed, as illustrated in FIG. 12, the display control unit 82 displays the position icon 111 corresponding to the position that has not been corrected in a white circle. In addition, the display control unit 82 displays the position icon 202 corresponding to the corrected position in a white circle and larger than the position icon 111.

As a result, since the position icon 202 is larger than the normal position icon 111 that has not been corrected, the user can easily grasp that the position has been corrected.

In another example of the pattern in which the shape of the position icon is changed and displayed, as illustrated in FIG. 13, the display control unit 82 displays the position icon 111 corresponding to the position that has not been corrected in a white circle. Furthermore, the display control unit 82 displays the position icon 203 corresponding to the corrected position in a white star shape.

As a result, since the shape of the position icon 203 is different from that of the normal position icon 111 that has not been corrected, the user can easily grasp that the position has been corrected.

Note that the display control unit 82 may display the position icons 202 and 203 in black, for example, by combining a pattern in which the color of the position icon is changed and displayed and a pattern in which the shape of the position icon is changed and displayed.

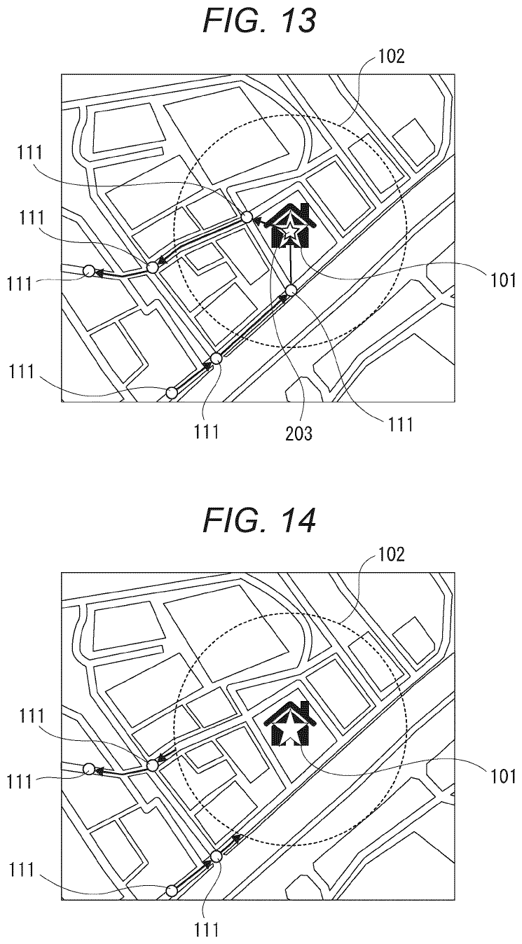

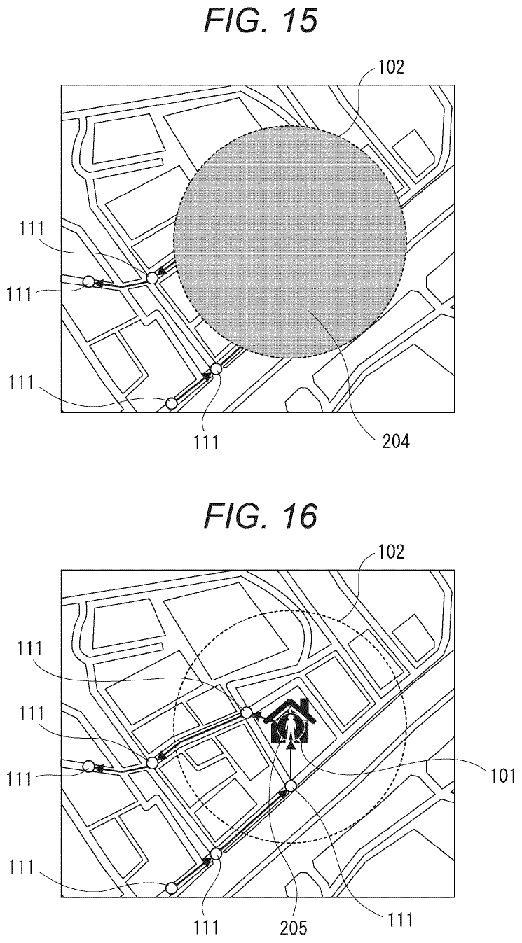

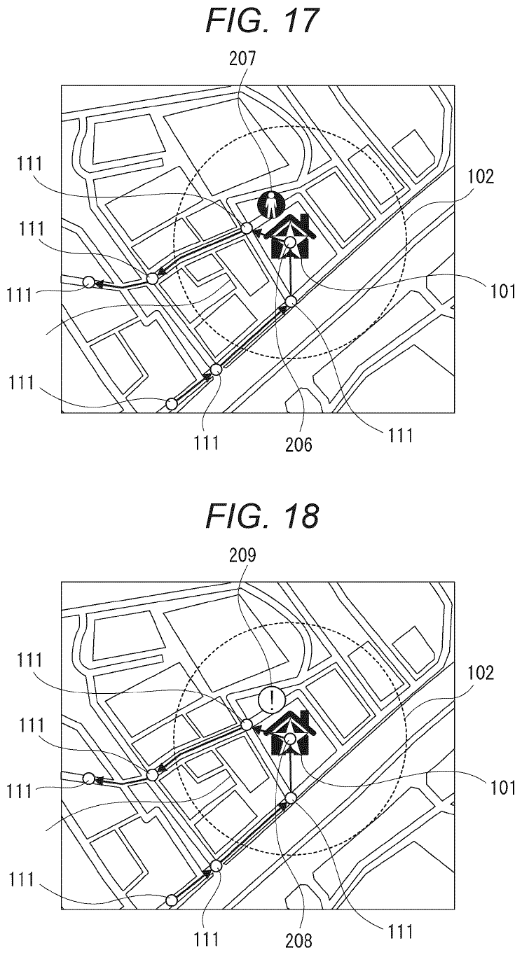

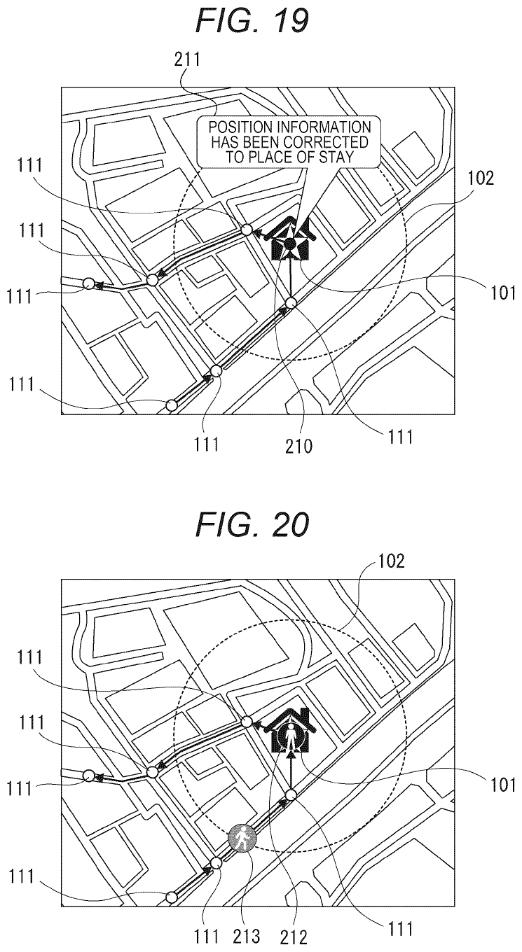

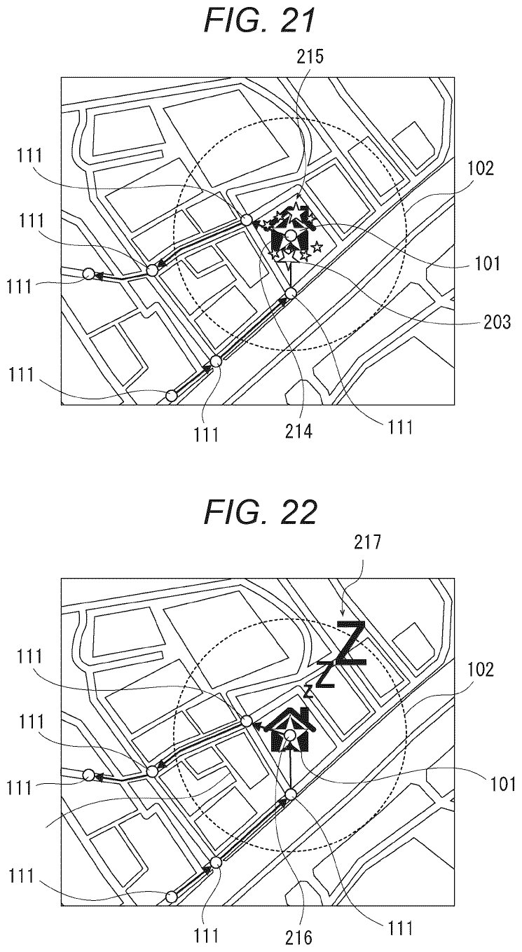

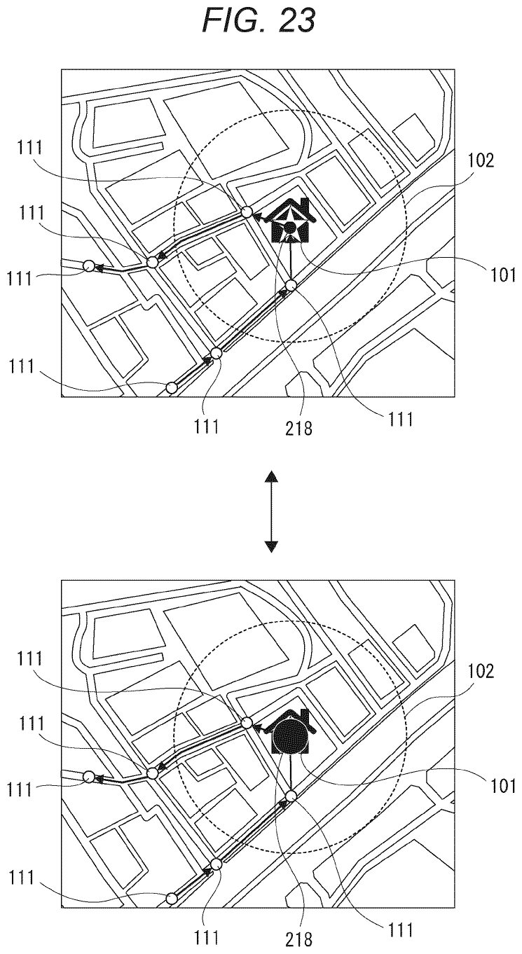

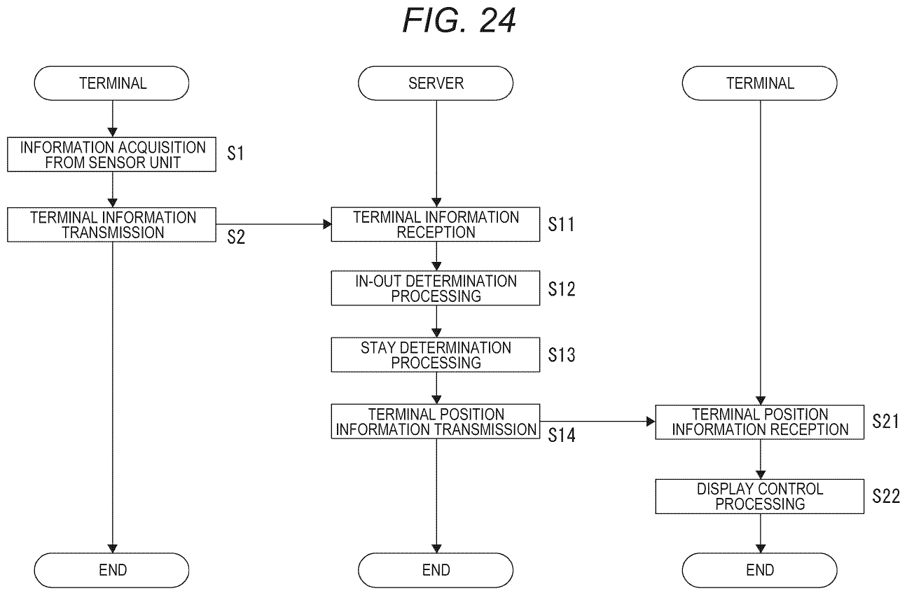

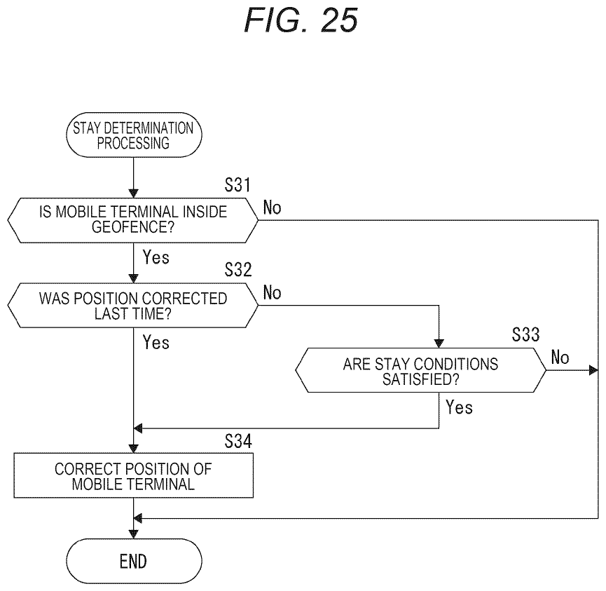

In addition, in another example of the pattern in which the shape of the position icon is changed and displayed, as illustrated in FIG. 14, the display control unit 82 displays the position icon 111 corresponding to the uncorrected position in a white circle. Furthermore, the display control unit 82 hides the movement trajectory 110 (position icon 111 or movement route 112) in the geofence 102 including the position icon corresponding to the corrected position. This makes it possible to indicate that the mobile terminal 2 stays at the destination 101 (in the geofence 102).

Therefore, since the position icon 111 is not displayed in the geofence 102, the user can easily grasp that the mobile terminal 2 stays at least in the geofence 102.

In addition, in another example of the pattern in which the shape of the position icon is changed and displayed, as illustrated in FIG. 15, the display control unit 82 displays the position icon 111 corresponding to the uncorrected position in a white circle. Furthermore, the display control unit 82 fills the inside of the geofence 102 including the position icon corresponding to the corrected position with a predetermined color (for example, gray, or the like) and displays the icon as the position icon 204.

Therefore, the position icon 204 has substantially the same size and shape as those of the geofence 102. Note that the position icon 204 is preferably displayed in a color different from the color of the position icon 111.

As a result, since the position icon 204 is displayed so as to overlap the geofence 102, the user can easily grasp that the mobile terminal 2 stays at least in the geofence 102.

In addition, in another example of the pattern in which the shape of the position icon is changed and displayed, as illustrated in FIG. 16, the display control unit 82 displays the position icon 111 corresponding to the uncorrected position in a white circle. In addition, the display control unit 82 displays a position icon 205 corresponding to the corrected position. The position icon 205 is different in content from the position icon 111, and is not simply shaped to indicate the position, but a person standing is drawn in white in a black circle.

As a result, the user can easily grasp that the position has been corrected only by viewing the position icon 205.

In the pattern of displaying the supplementary information around the position icon of the corrected position, as illustrated in FIG. 17, the display control unit 82 displays the position icon 111 corresponding to the position that has not been corrected in a white circle. In addition, the display control unit 82 displays the position icon 206 at the corrected position in a white circle, and displays the correction icon 207 in the vicinity of the position icon 206. The correction icon 207 is similar to the position icon 205 illustrated in FIG. 16.

As a result, even if the position icon 206 having the same color and the same shape as the position icon 111 is displayed at the corrected position, the user can easily grasp that the position has been corrected by displaying the correction icon 207 in the vicinity thereof.

In another example of the pattern of displaying the supplementary information around the position icon of the corrected position, as illustrated in FIG. 18, the display control unit 82 displays the position icon 111 corresponding to the position that has not been corrected in a white circle. In addition, the display control unit 82 displays the position icon 208 at the corrected position in a white circle, and displays the correction icon 209 in the vicinity of the position icon 208. The correction icon 209 is displayed in red in a white circle as “!”.

As a result, even if the position icon 208 having the same color and the same shape as the position icon 111 is displayed at the corrected position, the user can easily grasp that the position has been corrected by displaying the correction icon 209 in the vicinity thereof.

In another example of the pattern of displaying the supplementary information around the position icon of the corrected position, as illustrated in FIG. 19, the display control unit 82 displays the position icon 111 corresponding to the position that has not been corrected in a white circle. In addition, the display control unit 82 displays the position icon 210 at the corrected position in a black circle, and displays the speech bubble 211 in the vicinity of the position icon 210 at the corrected position.

The speech bubble 211 includes characters indicating that the position has been corrected, for example, “the position information has been corrected to the place of stay”.

As a result, the user can easily grasp that the position has been corrected by checking the position icon 210 and the speech bubble 211.

Note that the position icon 210 may be displayed in a white circle similarly to the position icon 111.

In addition, the speech bubble 211 may be displayed in accordance with an operation of the operation input unit 45. In this case, first, the display control unit 82 displays the position icon 111 corresponding to the uncorrected position in a white circle, and displays the position icon 210 in a black circle at the corrected position. At this time, the speech bubble 211 is hidden. Then, in a case where a tap operation is performed on the position icon 210, the display control unit 82 displays the speech bubble 211.

In this manner, by displaying the speech bubble 211 when the operation input unit 45 is operated, when the position icon 210 is displayed for the first time, the description is displayed in response to the user tapping the screen, and the speech bubble 211 is intentionally hidden for the second and subsequent times, whereby redundant description can be omitted and complexity can be avoided.

In the pattern in which animation display is performed around the position icon of the corrected position, as illustrated in FIG. 20, the display control unit 82 displays the position icon 111 corresponding to the position that has not been corrected in a white circle. In addition, the display control unit 82 displays the position icon 212 corresponding to the corrected position. The position icon 212 is different in content from the position icon 111, and is not simply shaped to indicate the position, but a person standing is drawn in white in a black circle.

Furthermore, the display control unit 82 moves and displays the movement icon 213 on the movement trajectory 110 in time series. As the movement icon 213, for example, a person walking is drawn in white in a blue circle.

As a result, the user can more clearly grasp the movement route of the moving person by confirming the movement icon 213, and since the shape of the position icon 212 is different from that of the normal position icon 111 that is not corrected, it is possible to easily grasp that the position is corrected.

In another example of the pattern for displaying animation around the position icon at the corrected position, as illustrated in FIG. 21, the display control unit 82 displays the position icon 111 corresponding to the position that has not been corrected in a white circle. In addition, the display control unit 82 displays the position icon 214 at the corrected position in a white circle, and rotates and displays a plurality of star-shaped emphasis icons 215 around the position icon 214. Note that the position icon 214 may have a color and a shape different from those of the position icon 111. Furthermore, the emphasis icon 215 may have a shape other than the star shape, the number thereof may be any number, and the color may be any color.

As a result, since the position icon 214 surrounded by the emphasis icon 215 can be made conspicuous, the user can easily grasp that the position has been corrected.

In another example of the pattern for displaying animation around the position icon at the corrected position, as illustrated in FIG. 22, the display control unit 82 displays the position icon 111 corresponding to the position that has not been corrected in a white circle. Furthermore, the display control unit 82 displays the position icon 216 at the corrected position in a white circle, and displays the character icon 217 including three characters “Z” of different sizes in an animation manner in the vicinity of the position icon 216.

In the animation display here, the letter “Z” appears repeatedly in the sequence of one, two, three, one, . . . and so on.

Note that the position icon 216 may have a color and a shape different from those of the position icon 111. Furthermore, the characters of the character icon 217 may be other than this.

This makes it easy to grasp that the mobile terminal 2 stays at the destination 101 by the character icon 217.

In another example of the pattern for displaying animation around the position icon at the corrected position, as illustrated in FIG. 23, the display control unit 82 displays the position icon 111 corresponding to the position that has not been corrected in a white circle. In addition, the display control unit 82 displays the position icon 218 in a black circle at the corrected position. The position icon 218 is subjected to animation display in which the shape is repeatedly changed in size.

As a result, since the position icon 218 is highlighted, the user can easily grasp that the mobile terminal 2 stays.

### 2-5. Processing Flow

FIG. 24 is a sequence chart illustrating a flow of processing in the information processing system 1. As illustrated in FIG. 24, in step S1, the CPU 11 of the mobile terminal 2 acquires a measurement result (position information or state information) from the sensor unit 20 at predetermined intervals. Then, in step S2, the CPU 11 of the mobile terminal 2 transmits terminal information including the position information and the state information to the server 3.

In the server 3, in step S11, the CPU 31 receives the terminal information transmitted from the mobile terminal 2. In step S12, the CPU 31 of the server 3 performs the in-out determination on the basis of the received terminal information (position information). Thereafter, in step S13, the CPU 31 of the server 3 performs stay determination on the basis of the determination result of the in-out determination and the terminal information transmitted from the mobile terminal 2. Note that a detailed flow of the stay determination will be described later.

In step S14, the CPU 31 of the server 3 transmits the terminal information, the determination result of the in-out determination, and the determination result of the stay determination as the terminal position information to the notification terminal 4.

In the notification terminal 4, in step S21, the CPU 41 receives the terminal position information transmitted from the server 3. Thereafter, in step S22, the CPU 41 displays an image on the display unit 46 on the basis of the received terminal position information. Here, for example, in a case where the position of the mobile terminal 2 has been corrected, the CPU 41 displays an image notifying that the position of the mobile terminal 2 has been corrected on the display unit 46 in the display pattern illustrated in FIGS. 11 to 23.

FIG. 25 is a flowchart illustrating a flow of stay determination processing. As illustrated in FIG. 25, when the stay determination processing is started, in step S31, the CPU 31 determines whether the mobile terminal 2 has entered the geofence 102 on the basis of the determination result in the in-out determination processing (step S12).

In a case where the mobile terminal 2 has entered the geofence 102 (Yes in step S31), in step S32, the CPU 31 determines whether the position of the mobile terminal 2 has been corrected to the destination 101 in the previous stay determination processing. The previous stay determination processing here refers to stay determination processing for terminal information transmitted from the mobile terminal 2 one time before terminal information transmitted from the mobile terminal 2 to be subjected to the current stay determination processing.

In a case where the position of the mobile terminal 2 has not been corrected to the destination 101 in the previous stay determination processing (No in step S32), in step S33, the CPU 31 determines whether the mobile terminal 2 stays at the destination 101 on the basis of the stay condition described above. In a case where the mobile terminal 2 stays at the destination 101 (Yes in step S33), the CPU 31 corrects the position of the mobile terminal 2 to the position of the destination 101 in step S34, and generates correction information indicating the correction. The correction information generated here is transmitted to the notification terminal 4 as part of the terminal position information in step S14 described above.

In addition, also in a case where the position of the mobile terminal 2 has been corrected to the destination 101 in the previous stay determination processing (Yes in step S32), the CPU 31 corrects the position of the mobile terminal 2 to the position of the destination 101 in step S34 and generates correction information indicating the correction. Therefore, in a case where the mobile terminal 2 enters the geofence 102 and satisfies the stay condition even once, the position of the mobile terminal 2 is continuously corrected to the position of the destination 101 regardless of whether or not the stay condition is satisfied until the mobile terminal 2 exits the geofence 102.

On the other hand, in a case where it is determined that the mobile terminal 2 has not entered the geofence 102 (No in step S31), the CPU 31 ends the processing without correcting the position of the mobile terminal 2 to the position of the destination 101.

### 3. Modifications

As described above, the information processing system 1 as an embodiment is not limited to the specific example described above, and can adopt configurations as various modifications.

For example, in the above-described embodiment, the CPU 31 of the server 3 functions as the terminal information acquisition unit 71, the in-out determination unit 72, and the stay determination unit 73. However, the CPU 41 of the notification terminal 4 or the CPU 11 of the mobile terminal 2 may function as the terminal information acquisition unit 71, the in-out determination unit 72, and the stay determination unit 73. In this case, the information processing system 1 may not be provided with the server 3.

In addition, in the above embodiment, in a case where it is determined that the mobile terminal 2 stays at the destination 101 by the stay determination, the position of the mobile terminal 2 is corrected to the position of the destination 101. However, in a case where it is determined that the mobile terminal 2 stays at the destination 101 by the stay determination, the position of the mobile terminal 2 may be corrected to another position in the geofence 102.

In addition, in the above embodiment, the position information is generated on the basis of the GNSS signal. However, as long as the position of the mobile terminal 2 can be generated, the position information may be generated by various methods such as base station positioning, indoor messaging system (IMES), Wi-Fi positioning, and Bluetooth (registered trademark) positioning.

In addition, in the above embodiment, one mobile terminal 2 is provided. However, in the information processing system 1, a plurality of mobile terminals 2 may be provided.

In addition, in the embodiment described above, the mobile terminal 2 is a dedicated terminal that is not provided with a display unit, but the mobile terminal 2 may be, for example, a smartphone.

### 4. Summary of Embodiments

As described above, the information processing apparatus (notification terminal 4) includes the display control unit 82 that performs display indicating that the position on the map 100 of the terminal apparatus (mobile terminal 2) has been corrected in a case where the position on the map 100 of the terminal apparatus (mobile terminal 2) staying in the predetermined designated region (geofence 102) has been corrected on the basis of the position information acquired by the terminal apparatus (mobile terminal 2).

As a result, the notification terminal 4 corrects the position of the mobile terminal 2 to the position inside the geofence 102, more specifically, the position of the destination 101 in a case where it is determined that the mobile terminal 2 stays inside the geofence 102 even in a case where the GNSS signal cannot be received, the GNSS signal reflected by a building is received, or the GNSS signal is weakened.

Then, in a case where the position of the mobile terminal 2 has been corrected, the display control unit 82 displays a notification of the correction on the display unit 46.

In this way, the notification terminal 4 can reduce that the mobile terminal 2 does not reach the destination 101 or the mobile terminal 2 frequently moves around the destination 101, and display the position of the mobile terminal 2 in an easily understandable manner.

The display control unit 82 corrects the position of the terminal apparatus (mobile terminal 2) on the map 100 to the position of the destination 101 in the designated region (geofence 102) and displays the corrected position.

As a result, the notification terminal 4 corrects the position of the mobile terminal 2 to the position of the destination 101, so that the user can grasp that the mobile terminal 2 has arrived and stayed at the destination 101.

The display control unit 82 displays the position of the terminal apparatus (mobile terminal 2) on the map 100 based on the position information in a predetermined color, and in a case where the position of the terminal apparatus (mobile terminal 2) on the map 100 is corrected, displays the position in a color different from that in a case where the position is not corrected. As a result, as illustrated in FIG. 11, since the color of the position icon 201 is different from the color of the normal position icon 111 that has not been corrected, the user can easily grasp that the position has been corrected.

Thus, the notification terminal 4 can easily grasp and display the position of the mobile terminal 2.

The display control unit 82 displays the position of the terminal apparatus (mobile terminal 2) on the map 100 based on the position information in a predetermined shape, and displays a case where the position of the terminal apparatus (mobile terminal 2) on the map 100 is corrected in a shape different from a case where the position is not corrected.

As a result, as illustrated in FIGS. 12 and 13, since the shapes of the position icons 202 and 203 are different from the shape of the normal position icon 111 that is not corrected, the user can easily grasp that the position is corrected.

Thus, the notification terminal 4 can easily grasp and display the position of the mobile terminal 2.

The display control unit 82 displays the position on the map 100 of the terminal apparatus (mobile terminal 2) based on the position information in a predetermined shape, and hides the position on the map 100 of the terminal apparatus (mobile terminal 2) in the designated region (geofence 102) in a case where the position on the map 100 of the terminal apparatus (mobile terminal 2) is corrected.

As a result, as illustrated in FIG. 14, it is possible to indicate that the mobile terminal 2 stays at the destination 101 by hiding the position icon 111 on the geofence 102.

Therefore, since the position icon 111 is not displayed in the geofence 102, the user can easily grasp that the mobile terminal 2 stays at least in the geofence 102.

Thus, the notification terminal 4 can easily grasp and display the position of the mobile terminal 2.

The display control unit 82 displays the position of the terminal apparatus (mobile terminal 2) on the map 100 based on the position information in a predetermined shape, and displays the entire designated region (geofence 102) as the position of the terminal apparatus (mobile terminal 2) on the map 100 in a case where the position of the terminal apparatus (mobile terminal 2) on the map 100 is corrected.

As a result, as illustrated in FIG. 15, since the position icon 204 is displayed so as to overlap the geofence 102, the user can easily grasp that the mobile terminal 2 stays at least in the geofence 102.

Thus, the notification terminal 4 can easily grasp and display the position of the mobile terminal 2.

The display control unit 82 displays the position of the terminal apparatus (mobile terminal 2) on the map 100 based on the position information in a predetermined shape, and in a case where the position of the terminal apparatus (mobile terminal 2) on the map 100 is corrected, displays a mark different from the case where the position of the terminal apparatus (mobile terminal 2) on the map 100 is not corrected.

The mark here is the position icon 205 illustrated in FIG. 16.

As a result, since the position icon 205 is a mark significantly different from the normal position icon 111 that has not been corrected, the user can easily grasp that the position has been corrected.

Thus, the notification terminal 4 can easily grasp and display the position of the mobile terminal 2.

In a case where the position of the terminal apparatus (mobile terminal 2) on the map 100 is corrected, the display control unit 82 displays supplementary information indicating that the position of the terminal apparatus (mobile terminal 2) on the map 100 is corrected.

The supplementary information is the position icon 205 illustrated in FIG. 16, the correction icon 207 illustrated in FIG. 17, the correction icon 209 illustrated in FIG. 18, the position icon 210 illustrated in FIG. 19, and the speech bubble 211.

In this way, by displaying the correction information in a case where the position of the mobile terminal 2 has been corrected, the user can easily grasp that the position has been corrected.

Thus, the notification terminal 4 can easily grasp and display the position of the mobile terminal 2.

The display control unit 82 displays the position of the terminal apparatus (mobile terminal 2) on the map 100 based on the position information in a predetermined shape. In a case where the position of the terminal apparatus (mobile terminal 2) on the map 100 is corrected, the display control unit displays the corrected position of the terminal apparatus (mobile terminal 2) on the map 100 in the same shape as that of the case where the position is not corrected, and displays supplementary information around the corrected position.

The supplementary information here is the correction icon 207 illustrated in FIG. 17 or the correction icon 209 illustrated in FIG. 18.

As described above, in a case where the position of the mobile terminal 2 is corrected, the user can easily grasp that the position is corrected by displaying the correction information around the corrected position.

Thus, the notification terminal 4 can easily grasp and display the position of the mobile terminal 2.

The display control unit 82 displays the position of the terminal apparatus (mobile terminal 2) on the map 100 based on the position information in a predetermined shape. In a case where the position of the terminal apparatus (mobile terminal 2) on the map 100 is corrected, the display control unit displays the corrected position of the terminal apparatus (mobile terminal 2) on the map 100 in the same shape as the case where the position is not corrected, and displays a mark different from the position of the terminal apparatus (mobile terminal 2) that is not corrected around the corrected position of the terminal apparatus on the map 100.

Here, the mark is the correction icon 207 illustrated in FIG. 17 or the correction icon 209 illustrated in FIG. 18.

As described above, in a case where the position of the mobile terminal 2 is corrected, even if the position icons 206 and 208 are displayed in the same color and shape as the position icon 111, the user can easily grasp that the position is corrected by displaying the correction information around the corrected position.

Thus, the notification terminal 4 can easily grasp and display the position of the mobile terminal 2.

The display control unit 82 displays the position of the terminal apparatus (mobile terminal 2) on the map 100 based on the position information in a predetermined shape, and in a case where the position of the terminal apparatus (mobile terminal 2) on the map 100 is corrected, characters (speech bubble 211) notifying the correction are displayed around the corrected position of the terminal apparatus (mobile terminal 2) on the map 100.

As a result, it is possible to notify that the position of the mobile terminal 2 has been corrected by characters.

Thus, the notification terminal 4 can easily grasp and display the position of the mobile terminal 2.

The operation input unit 45 operable by a user is provided, and the display control unit 82 displays supplementary information according to an operation of the user on the operation input unit 45.

The supplementary information here is the speech bubble 211 illustrated in FIG. 19.

In this manner, by displaying the speech bubble 211 when the operation input unit 45 is operated, when the position icon 210 is displayed for the first time, the description is displayed in response to the user tapping the screen, and the speech bubble 211 is intentionally hidden for the second and subsequent times, whereby redundant description can be omitted and complexity can be avoided.

The display control unit 82 displays the position of the terminal apparatus (mobile terminal 2) on the map 100 based on the position information in a predetermined color and shape, and in a case where the position of the terminal apparatus (mobile terminal 2) on the map 100 is corrected, displays the corrected position of the terminal apparatus (mobile terminal 2) on the map 100 in a color or shape different from that in a case where the position is not corrected, and displays characters notifying that the position is corrected around the corrected position of the terminal apparatus on the map 100 according to the user's operation on the operation input unit 45.

As a result, the notification terminal 4 can first notify that the position has been corrected with the position icon 210, and display more details when the operation input unit 45 is operated.

In a case where the position of the terminal apparatus (mobile terminal 2) on the map 100 has been corrected, the display control unit 82 performs animation display indicating that the position of the terminal apparatus (mobile terminal 2) on the map 100 has been corrected.

The animation display here is the movement icon 213 illustrated in FIG. 20, the emphasis icon 215 illustrated in FIG. 21, the character icon 217 illustrated in FIG. 22, or the position icon 218 illustrated in FIG. 23.

As described above, by performing animation display in a case where the position of the mobile terminal 2 has been corrected, the user can easily grasp that the position has been corrected.

Thus, the notification terminal 4 can easily grasp and display the position of the mobile terminal 2.

The display control unit 82 displays the position of the terminal apparatus (mobile terminal 2) on the map 100 based on the position information in a predetermined shape, and in a case where the position of the terminal apparatus (mobile terminal 2) on the map 100 is corrected, displays the corrected position of the terminal apparatus (mobile terminal 2) on the map 100 in the same shape as that in a case where the position is not corrected, and displays a predetermined mark in animation around the corrected position of the terminal apparatus (mobile terminal 2) on the map 100.

The animation display here is the movement icon 213 illustrated in FIG. 20 or the emphasis icon 215 illustrated in FIG. 21.

As described above, by performing animation display in a case where the position of the mobile terminal 2 has been corrected, the user can easily grasp that the position has been corrected.

Thus, the notification terminal 4 can easily grasp and display the position of the mobile terminal 2.

The display control unit 82 displays the position of the terminal apparatus (mobile terminal 2) on the map 100 based on the position information in a predetermined shape, and in a case where the position of the terminal apparatus (mobile terminal 2) on the map 100 is corrected, performs animation display of changing the shape to the position of the corrected terminal apparatus on the map 100.

The animation display here is the position icon 218 illustrated in FIG. 23.

As described above, by performing animation display in a case where the position of the mobile terminal 2 has been corrected, the user can easily grasp that the position has been corrected.

Thus, the notification terminal 4 can easily grasp and display the position of the mobile terminal 2.

When the terminal apparatus (mobile terminal 2) has entered the designated region (geofence 102) and a predetermined stay condition is satisfied, it is determined that the terminal apparatus (mobile terminal 2) stays in the designated region (geofence 102).

As a result, since it is determined that the mobile terminal 2 stays at the destination 101 at least in a case where the mobile terminal 2 has entered the geofence 102, the stay determination is performed with high accuracy.

Whether the terminal apparatus stays in the designated region is determined on the basis of the acceleration or the position information acquired by the terminal apparatus (mobile terminal 2).

As a result, since it is determined that the mobile terminal 2 stays at the destination 101 when the mobile terminal 2 hardly moves, the stay determination is accurately performed.

In addition, in a case where the position on the map 100 of the terminal apparatus staying in the predetermined designated region is corrected on the basis of the position information acquired by the terminal apparatus, the information processing method performs display indicating that the position on the map 100 of the terminal apparatus is corrected.

Further, in a case where the position on the map 100 of the terminal apparatus staying in the predetermined designated region is corrected on the basis of the position information acquired by the terminal apparatus, the program causes the information processing apparatus (notification terminal 4) to execute processing of performing display indicating that the position on the map 100 of the terminal apparatus has been corrected.

This program is a program that implements the functions of the information processing apparatus described above in a computer.

Furthermore, according to the recording medium of the present invention in which such a program of the present invention is recorded, provision of the program becomes easy, and the present invention can be widely and generally provided.

This program can be recorded in advance in an HDD as a recording medium built in equipment such as a computer, a ROM in a CPU, or the like.

Alternatively, the program can be temporarily or permanently stored (recorded) in a removable recording medium such as a flexible disk, a compact disc read only memory (CD-ROM), a magnet optical (MO) disk, a digital versatile disc (DVD), a magnetic disk, or a semiconductor memory. Such a removable recording medium can be provided as so-called package software.

Furthermore, the program can be installed from a removable recording medium to a computer or the like, or can be downloaded from a download site via a network such as a local area network (LAN) or the Internet.

Note that the effects described in the present specification are merely examples and are not limited, and other effects may be provided.

### 5. Present Technology

Note that the present technology can also adopt the following configurations.
(1)
An information processing apparatus including
a display control unit that, in a case where a position on a map of a terminal apparatus staying in a designated region predetermined is corrected on the basis of position information acquired by the terminal apparatus, performs display indicating that the position on the map of the terminal apparatus has been corrected.
(2)
The information processing apparatus according to (1), in which
the display control unit is configured to
correct and display a position of the terminal apparatus on the map to a position of a destination in the designated region.
(3)
The information processing apparatus according to (1) or (2), in which
the display control unit is configured to
display the position of the terminal apparatus on the map based on the position information in a predetermined color, and display the position of the terminal apparatus on the map in a color different from a case where the position is not corrected in a case where the position is corrected.
(4)
The information processing apparatus according to any one of (1) to (3), in which
the display control unit is configured to
display the position of the terminal apparatus on the map based on the position information in a predetermined shape, and display the position of the terminal apparatus on the map in a shape different from a case where the position of the terminal apparatus on the map is not corrected in a case where the position of the terminal apparatus on the map is corrected.
(5)
The information processing apparatus according to (1), in which
the display control unit is configured to
display the position of the terminal apparatus on the map based on the position information in a predetermined shape, and hide the position of the terminal apparatus on the map in the designated region in a case where the position of the terminal apparatus on the map is corrected.
(6)
The information processing apparatus according to any one of (1) to (4), in which
the display control unit is configured to
display the position of the terminal apparatus on the map based on the position information in a predetermined shape, and display the designated region entire as the position of the terminal apparatus on the map in a case where the position of the terminal apparatus on the map is corrected.
(7)
The information processing apparatus according to any one of (1) to (4), in which
the display control unit is configured to
display the position on the map of the terminal apparatus based on the position information in a predetermined shape, and display a mark different from a case where the position on the map of the terminal apparatus is not corrected on a corrected position on the map of the terminal apparatus in a case where the position on the map of the terminal apparatus is corrected.
(8)
The information processing apparatus according to any one of (1) to (7), in which
the display control unit is configured to
display supplementary information indicating that the position of the terminal apparatus on the map has been corrected in a case where the position of the terminal apparatus on the map has been corrected.
(9)
The information processing apparatus according to (8), in which
the display control unit is configured to
display the position of the terminal apparatus on the map based on the position information in a predetermined shape, and display a corrected position of the terminal apparatus on the map in a same shape as that in a case where the position of the terminal apparatus on the map is uncorrected and display the supplementary information around the corrected position of the terminal apparatus on the map.
(10)
The information processing apparatus according to (9), in which
the display control unit is configured to
display the position of the terminal apparatus on the map based on the position information in a predetermined color and shape, and in a case where the position of the terminal apparatus on the map is corrected, display the corrected position of the terminal apparatus on the map in a same color and shape as in a case where the position is not corrected, and display a mark different from an uncorrected position of the terminal apparatus on the map around the corrected position of the terminal apparatus on the map.
(11)
The information processing apparatus according to any one of (8) to (10), in which
the display control unit is configured to
display the position of the terminal apparatus on the map based on the position information in a predetermined shape, and in a case where the position of the terminal apparatus on the map is corrected, display characters notifying that correction has been made around the corrected position of the terminal apparatus on the map.
(12)
The information processing apparatus according to any one of (8) to (11), further including
an operation input unit operable by a user, in which
the display control unit displays the supplementary information according to a user's operation on the operation input unit.
(13)
The information processing apparatus according to (12), in which
the display control unit is configured to
display the position of the terminal apparatus on the map based on the position information in a predetermined color and shape, display a corrected position of the terminal apparatus on the map in a color or shape different from a case where the position of the terminal apparatus on the map is not corrected in a case where the position of the terminal apparatus on the map is corrected, and display characters notifying that the position of the terminal apparatus on the map is corrected around the corrected position of the terminal apparatus in accordance with an operation of the user to the operation input unit.
(14)
The information processing apparatus according to (1), in which
the display control unit is configured to
perform animation display indicating that the position of the terminal apparatus on the map has been corrected in a case where the position of the terminal apparatus on the map has been corrected.
(15)
The information processing apparatus according to (14), in which
the display control unit is configured to
display the position of the terminal apparatus on the map based on the position information in a predetermined color and shape, and in a case where the position of the terminal apparatus on the map is corrected, display a corrected position of the terminal apparatus on the map in a same color and shape as in a case where the position is not corrected, and display a predetermined mark in animation around the corrected position of the terminal apparatus on the map.
(16)
The information processing apparatus according to (14), in which
the display control unit is configured to
display the position of the terminal apparatus on the map based on the position information in a shape predetermined, and perform animation display of changing the shape to the corrected position of the terminal apparatus on the map in a case where the position of the terminal apparatus on the map is corrected.
(17)
The information processing apparatus according to any one of (1) to (16), in which
the terminal apparatus is determined to stay in the designated region when the terminal apparatus has entered the designated region and a predetermined stay condition is satisfied.
(18)
The information processing apparatus according to any one of (1) to (17), in which
whether the terminal apparatus stays in the designated region is determined on the basis of acceleration or the position information acquired by the terminal apparatus.
(19)
An information processing method including,
in a case where a position on a map of a terminal apparatus staying in a designated region predetermined is corrected on the basis of position information acquired by the terminal apparatus, performing display indicating that the position on the map of the terminal apparatus has been corrected
(20)
A program for causing an information processing apparatus to execute processing of, in a case where a position on a map of a terminal apparatus staying in a designated region predetermined is corrected on the basis of position information acquired by the terminal apparatus, performing display indicating that the position on the map of the terminal apparatus has been corrected.

### REFERENCE SIGNS LIST

1 Information processing system 1
2 Mobile terminal (terminal apparatus)
3 Server
4 Notification terminal (information processing apparatus)
11 CPU
31 CPU
41 CPU
61 Position information acquisition unit
62 State information acquisition unit
71 Terminal information acquisition unit
72 In-out determination unit
73 Stay determination unit
81 Terminal position information acquisition unit
82 Display control unit

1. An information processing apparatus comprising
a display control unit that, in a case where a position on a map of a terminal apparatus staying in a designated region predetermined is corrected on a basis of position information acquired by the terminal apparatus, performs display indicating that the position on the map of the terminal apparatus has been corrected.

2. The information processing apparatus according to claim 1, wherein
the display control unit is configured to
correct and display a position of the terminal apparatus on the map to a position of a destination in the designated region.

3. The information processing apparatus according to claim 1, wherein
the display control unit is configured to
display the position of the terminal apparatus on the map based on the position information in a predetermined color, and display the position of the terminal apparatus on the map in a color different from a case where the position is not corrected in a case where the position is corrected.

4. The information processing apparatus according to claim 1, wherein
the display control unit is configured to
display the position of the terminal apparatus on the map based on the position information in a predetermined shape, and display the position of the terminal apparatus on the map in a shape different from a case where the position of the terminal apparatus on the map is not corrected in a case where the position of the terminal apparatus on the map is corrected.

5. The information processing apparatus according to claim 1, wherein
the display control unit is configured to
display the position of the terminal apparatus on the map based on the position information in a predetermined shape, and hide the position of the terminal apparatus on the map in the designated region in a case where the position of the terminal apparatus on the map is corrected.

6. The information processing apparatus according to claim 1, wherein
the display control unit is configured to
display the position of the terminal apparatus on the map based on the position information in a predetermined shape, and display the designated region entire as the position of the terminal apparatus on the map in a case where the position of the terminal apparatus on the map is corrected.

7. The information processing apparatus according to claim 1, wherein
the display control unit is configured to
display the position on the map of the terminal apparatus based on the position information in a predetermined shape, and display a mark different from a case where the position on the map of the terminal apparatus is not corrected on a corrected position on the map of the terminal apparatus in a case where the position on the map of the terminal apparatus is corrected.

8. The information processing apparatus according to claim 1, wherein
the display control unit is configured to
display supplementary information indicating that the position of the terminal apparatus on the map has been corrected in a case where the position of the terminal apparatus on the map has been corrected.

9. The information processing apparatus according to claim 8, wherein
the display control unit is configured to
display the position of the terminal apparatus on the map based on the position information in a predetermined shape, and display a corrected position of the terminal apparatus on the map in a same shape as that in a case where the position of the terminal apparatus on the map is uncorrected and display the supplementary information around the corrected position of the terminal apparatus on the map.

10. The information processing apparatus according to claim 9, wherein
the display control unit is configured to
display the position of the terminal apparatus on the map based on the position information in a predetermined color and shape, and in a case where the position of the terminal apparatus on the map is corrected, display the corrected position of the terminal apparatus on the map in a same color and shape as in a case where the position is not corrected, and display a mark different from an uncorrected position of the terminal apparatus on the map around the corrected position of the terminal apparatus on the map.

11. The information processing apparatus according to claim 8, wherein
the display control unit is configured to
display the position of the terminal apparatus on the map based on the position information in a predetermined shape, and in a case where the position of the terminal apparatus on the map is corrected, display characters notifying that correction has been made around the corrected position of the terminal apparatus on the map.

12. The information processing apparatus according to claim 8, further comprising
an operation input unit operable by a user, wherein
the display control unit displays the supplementary information according to a user's operation on the operation input unit.

13. The information processing apparatus according to claim 12, wherein
the display control unit is configured to
display the position of the terminal apparatus on the map based on the position information in a predetermined color and shape, display a corrected position of the terminal apparatus on the map in a color or shape different from a case where the position of the terminal apparatus on the map is not corrected in a case where the position of the terminal apparatus on the map is corrected, and display characters notifying that the position of the terminal apparatus on the map is corrected around the corrected position of the terminal apparatus in accordance with an operation of the user to the operation input unit.

14. The information processing apparatus according to claim 1, wherein
the display control unit is configured to
perform animation display indicating that the position of the terminal apparatus on the map has been corrected in a case where the position of the terminal apparatus on the map has been corrected.

15. The information processing apparatus according to claim 14, wherein
the display control unit is configured to
display the position of the terminal apparatus on the map based on the position information in a predetermined color and shape, and in a case where the position of the terminal apparatus on the map is corrected, display a corrected position of the terminal apparatus on the map in a same color and shape as in a case where the position is not corrected, and display a predetermined mark in animation around the corrected position of the terminal apparatus on the map.

16. The information processing apparatus according to claim 14, wherein
the display control unit is configured to
display the position of the terminal apparatus on the map based on the position information in a shape predetermined, and perform animation display of changing the shape to the corrected position of the terminal apparatus on the map in a case where the position of the terminal apparatus on the map is corrected.

17. The information processing apparatus according to claim 1, wherein
the terminal apparatus is determined to stay in the designated region when the terminal apparatus has entered the designated region and a predetermined stay condition is satisfied.

18. The information processing apparatus according to claim 1, wherein
whether the terminal apparatus stays in the designated region is determined on a basis of acceleration or the position information acquired by the terminal apparatus.

19. An information processing method comprising,
in a case where a position on a map of a terminal apparatus staying in a designated region predetermined is corrected on a basis of position information acquired by the terminal apparatus, performing display indicating that the position on the map of the terminal apparatus has been corrected.

20. A program for causing an information processing apparatus to execute processing of, in a case where a position on a map of a terminal apparatus staying in a designated region predetermined is corrected on a basis of position information acquired by the terminal apparatus, performing display indicating that the position on the map of the terminal apparatus has been corrected.
